(19) United States
(12) Patent Application Publication
(10) Pub. No.: US 2017/0237716 A1
(43) Pub. Date: Aug. 17, 2017

(54) SYSTEM AND METHOD FOR INTERLOCKING INTRUSION INFORMATION

(71) Applicant: ELECTRONICS AND TELECOMMUNICATIONS RESEARCH INSTITUTE, Daejeon (KR)

(72) Inventors: Jong Hyun KIM, Daejeon (KR); Ik Kyun KIM, Daejeon (KR); Joo Young LEE, Daejeon (KR); Sun Oh CHOI, Daejeon (KR); Yang Seo CHOI, Daejeon (KR)

(21) Appl. No.: 15/246,027

(22) Filed: Aug. 24, 2016

(30) Foreign Application Priority Data
Feb. 17, 2016 (KR) 10-2016-0018460

(51) Int. Cl. H04L 29/06

(52) U.S. Cl. CPC H04L 63/0435; H04L 63/0869; H04L 63/1425; H04L 63/0823; H04L 63/061

(57) ABSTRACT

The present invention relates to a system and method for interlocking intrusion information. An intrusion information interlocking system includes at least one interlocking client which is connected to a client system which collects session information of intrusion in different network domains to transmit the intrusion information collected by the client system to the control system and requests analysis information on the intrusion information in accordance with a request of the client system to provide the analysis information to the client system, and an interlocking server which is connected to a control system which analyzes intrusion information to transmit the intrusion information of different network domains provided from one or more interlocking clients to the control system, stores the intrusion analysis information from the control system, and shares the stored intrusion analysis information with the interlocking client in accordance with the request of the interlocking client.

### CROSS-REFERENCE TO RELATED APPLICATIONS

This application claims priority to and the benefit of Korean Patent Application No. 10-2016-0018460 filed in the Korean Intellectual Property Office on Feb. 17, 2016, the entire contents of which are incorporated herein by reference.

### TECHNICAL FIELD

The present invention relates to a system and method for interlocking intrusion information.

### BACKGROUND ART

In the related art, in order to correspond to a cyber-attack, a detecting rule or specific security event analysis is mainly performed. Therefore, there is a limitation in promptly figuring out a cause and performing a reactive process.

For example, it takes several months or more to analyze a cause of major intrusion such as 3.20 cyber terror attack and most attacks are not detected by security equipment in the related art. Further, in the related art, log information required to analyze a cause of attack does not remain, so that it is difficult to reveal the cause of attack.

It was found that 195 session information among collected 200 session information is an actual intrusion attack behavior which has not detected by a pattern based network security solution. Therefore, there is a limitation in network monitoring of the related art.

As described above, as a cyber-attack such as an advanced persistent threat (APT) attack becomes smarter, it takes several months or more to analyze a cause of intrusion and it is hard to detect most of the attacks using security equipment of the related art. Therefore, an interlocking of the apparatus for exchanging intrusion information which may efficiently cope with the cyber-attack is required.

### SUMMARY OF THE INVENTION

The present invention has been made in an effort to provide an intrusion information interworking system and method for sharing TCP/IP layer session information which is detected by various security systems such as an intrusion prevention system between network domains.

The present invention has been made in an effort to further provide an intrusion information interlocking system and method which collects attack symptoms which are not detected by the security equipment of the related art by sharing intrusion information between network domains and analyzes causes of internal intrusion of intrusion attacks which become smarter in recent years and are persisted over a long time, to promptly cope with the intrusion.

Technical objects of the present invention are not limited to the aforementioned technical objects and other technical objects which are not mentioned will be apparently appreciated by those skilled in the art from the following description.

An exemplary embodiment of the present invention provides an intrusion information interlocking system, including: at least one interlocking client which is connected to a client system which collects session information of intrusion in different network domains to transmit the intrusion information collected by the client system to the control system and requests analysis information on the intrusion information in accordance with a request of the client system to provide the analysis information to the client system; and an interlocking server which is connected to a control system which analyzes intrusion information to transmit the intrusion information of different network domains provided from one or more interlocking clients to the control system, stores the intrusion analysis information from the control system, and shares the stored intrusion analysis information with the interlocking client in accordance with the request of the interlocking client.

The one or more interlocking client and interlocking server may use different network domains.

The intrusion information may include at least one of a uniform resource locator (URL) and an internet protocol (IP) address of a malware code file, network traffic information related with the malware code, and internal intrusion analysis result data.

The interlocking client and the interlocking server may receive a certificate route for mutual authentication between the interlocking client and the interlocking server and check validity of communication connected between the interlocking client and the interlocking server based on the certificate of the route to perform mutual authentication.

The interlocking client and the interlocking server may connect a session for transport layer security (TLS) to exchange a secret key to be used for independent encryption communication and check the validity of the secret key to try symmetric key encryption connection.

The interlocking client may include a communication status management unit which periodically checks a communication status of a connection session for transporting the intrusion information between the interlocking client and the interlocking server and a connection session for polling the intrusion analysis information stored in the interlocking server. When the connection session between the interlocking client and the interlocking server is disconnected or there is no response for a predetermined time or longer, the communication status management unit ends the connection session and requests the mutual authentication.

The interlocking client may process the intrusion information collected by the client system based on a predetermined data model and transport the processed data to the interlocking server.

In the data model, a session message class for a message exchanged between different network domains may be defined in the top class, and in a lower class of the session message class, a connect class which includes session log information for network connection and a heartbeat class which includes operation status information of the interlocking system may be defined.

In the connect class, at least one of information on a device which transmits a connect message, policy information, information created for the connect message, sender information, destination information, sender information and destination information in which a network address to create the session connection is translated, and additional information may be defined.

In the heartbeat class, at least one of information on a device which transmits a heartbeat message, creation information of the heartbeat information, information on an interval when the heartbeat message is transmitted, and additional information may be defined.

The intrusion analysis information may include at least one of a URL and IP address of a file which is detected as a malware, a pseudo intrusion behavior of the malware file, an inflow path, and a changed circumstance of the malware file, and new intrusion analysis result data.

Another exemplary embodiment of the present invention provides an intrusion information interlocking method including receiving and storing, by an interlocking client, intrusion information from a client system which collects session information of intrusion, checking, by the interlocking client, a communication status between the interlocking client and the interlocking server to transmit the intrusion information to the interlocking server, transmitting, by the interlocking sever, the intrusion information in different network domains received from one or more interlocking clients to a control system, receiving, by the interlocking server, analysis information on the intrusion information from the control system to store the intrusion analysis information, and sharing stored intrusion analysis information by the interlocking server and the interlocking client when there is a request of the intrusion analysis information from the interlocking client.

The method may further include performing mutual authentication by receiving a certificate route for mutual authentication between the interlocking client and the interlocking server and checking validity of communication connected between the interlocking client and the interlocking server based on the certificate of the route.

The performing of mutual authentication may include connecting a session for transport layer security (TLS), exchanging a secret key used for encryption communication through the session connected for secure transmission, and checking validity of the secret key to try symmetric key encryption connection.

The method may further include periodically checking, by the interlocking client, a communication status of a connection session for transmitting intrusion information between the interlocking client and the interlocking server and a connection session for polling the intrusion analysis information stored in the interlocking server to end the connection session when the connection session is disconnected and there is no response for a set time or longer to request mutual authentication.

In the transmitting of the intrusion information to the interlocking server, the intrusion information collected by the client system may be processed based on a predetermined data model and the processed data may be transported to the interlocking server.

According to the present invention, TCP/IP layer session information which is detected by various security systems such as an intrusion prevention system is s hared between network domains to collect attack symptoms which are not detected by the security equipment of the related art and causes of internal intrusion by intrusion attacks which become smarter and are persisted over a long time are analyzed to promptly cope with the intrusion.

### BRIEF DESCRIPTION OF THE DRAWINGS

FIG. 1 is a view illustrating a configuration of an interlocking system according to an exemplary embodiment of the present invention.

FIG. 2 is a view illustrating a detailed device configuration of an interlocking system according to an exemplary embodiment of the present invention.

FIG. 3 is a view illustrating a data model of intrusion information of an interlocking system according to an exemplary embodiment of the present invention.

FIG. 4 is a view illustrating a flow of an authenticating system of an interlocking system according to an exemplary embodiment of the present invention.

FIG. 5 is a view illustrating a flow of an operation of an interlocking method according to an exemplary embodiment of the present invention.

FIG. 6 is a view illustrating a computing system to which an apparatus according to an exemplary embodiment of the present invention is applied.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the accompanying drawings. When reference numerals denote components in the drawings, even though the like components are illustrated in different drawings, it should be understood that like reference numerals refer to the same components. In describing the embodiments of the present invention, when it is determined that the detailed description of the known configuration or function related to the present invention may obscure the understanding of exemplary embodiments of the present invention, the detailed description thereof will be omitted.

In describing components of the exemplary embodiment of the present invention, terminologies such as first, second, A, B, (a), (b), and the like may be used. However, such terminologies are used only to distinguish a component from another component but nature, a sequence or an order of the component is not limited by the terminologies. If not contrarily defined, all terminologies used herein including technological or scientific terms have the same meaning as those generally understood by a person with ordinary skill in the art. Terminologies which are defined in a generally used dictionary should be interpreted to have the same meaning as the meaning in the context of the related art but are not interpreted as ideal or excessively formal meaning if they are not clearly defined in the present invention.

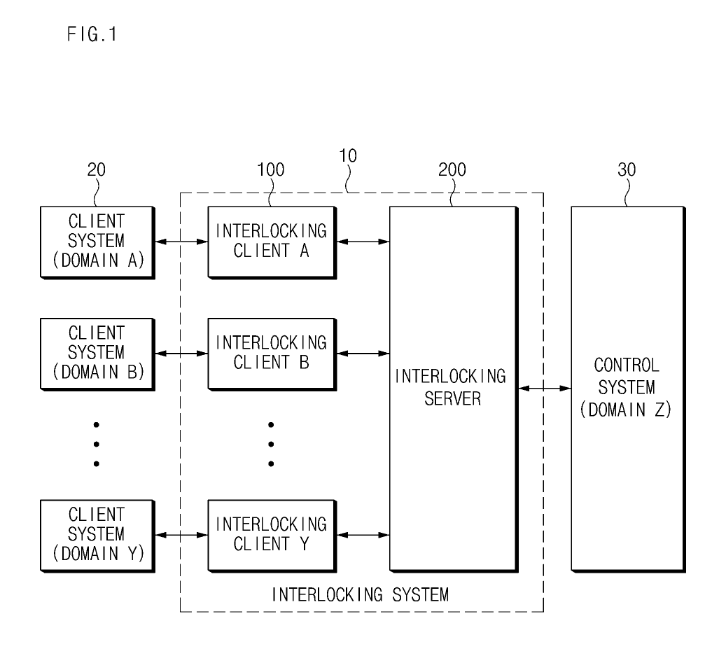

FIG. 1 is a view illustrating a configuration of an intrusion information interlocking system according to an exemplary embodiment of the present invention.

As illustrated in FIG. 1, an interlocking system according to an exemplary embodiment of the present invention may include an interlocking system 10 which shares intrusion information collected by a client system 20 and analysis information of intrusion between a lower level client system 20 and a higher level control system 30. In this case, the interlocking system 10 may include an interlocking client 100 which is connected to the client system 20 and an interlocking server 200 which is connected to the control system 30.

Here, the client system 20 may be a security system which collects and stores intrusion session information to analyze a cause of intrusion, as a single enterprise or an organization. The client system 20 collects the intrusion information which is generated in a network domain to transmit the intrusion information to the control system 30 through the interlocking system 10.

A plurality of client systems 20 may be provided. The plurality of client systems 20 may collect intrusion information which is generated in different network domains.

In this case, each client system 20 may be connected to the interlocking client 100 of the interlocking system 10. Therefore, the interlocking client 100 may provide the intrusion information collected from the connected client system 20 to the interlocking server 200 of the interlocking system 10. The interlocking client 100 may receive the analysis information on the intrusion information by requesting to the interlocking server 200.

The control system 30 may correspond to a security system provided in an intrusion response center or an integrated security control center. The control system 30 is connected to the interlocking server 200 of the interlocking system 10 and may receive intrusion information from the interlocking client 100 connected to different network domains through the interlocking server 200.

The control system 30 may analyze intrusion information of different network domains which is provided through the interlocking system 10 and share the intrusion analysis information with each client system 20 through the interlocking system 10.

In this case, information may also be exchanged between client systems 20 through the interlocking system 10.

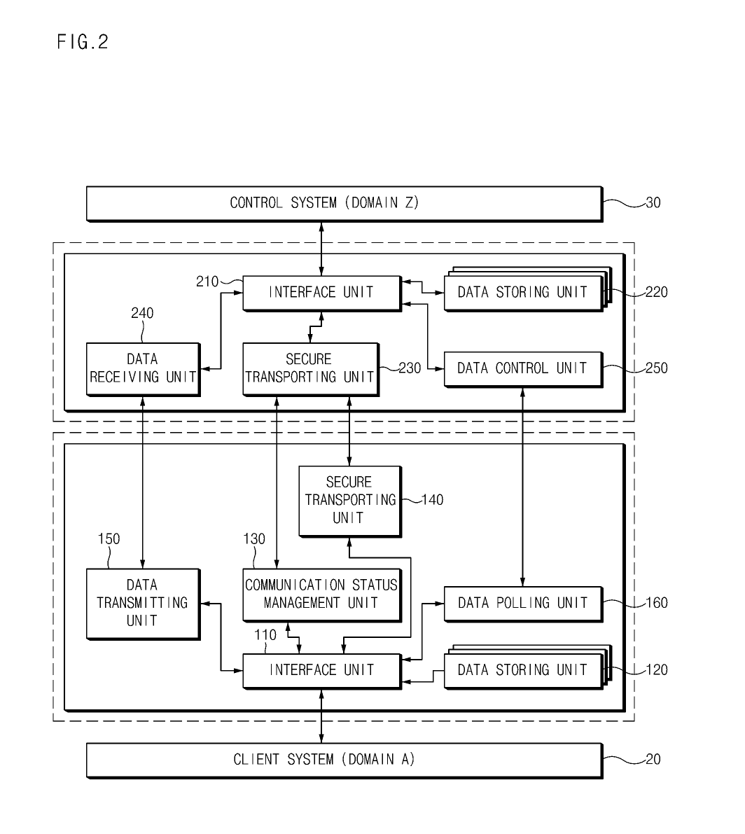

Detailed configurations of the interlocking client 100 and the interlocking server 200 will be described in more detail with reference to an exemplary embodiment of FIG. 2.

FIG. 2 is a view illustrating a detailed device configuration of an interlocking system according to an exemplary embodiment of the present invention.

As illustrated in FIG. 2, the interlocking client 100 may include an interface unit 110, a data storing unit 120, a communication status management unit 130, a security transporting unit 140, a data transmitting unit 150, and a data polling unit 160.

First, the interface unit 110 controls connection with the interlocking server 200 which is connected with the control system and the connection with the client system and serves to control a function for exchanging intrusion information of the client system and manage interlocking data.

To this end, in the interface unit 110, a request for confirmation of an operation status of the interlocking client 100 from the client system and the interlocking server 200, and/or a request for storing and deleting data may be input. Therefore, the interface may check the operation status of the data storing unit 120, the communication status management unit 130, the security transporting unit 140, the data transmitting unit 150, and the data polling unit 160 and create a result thoseof and then provide the created result.

The interface unit 110 may store data on intrusion information provided from the client system and intrusion analysis information provided from the control system in the data storing unit 120 or delete data stored in the data storing unit 120. In this case, the interface unit 110 may perform encryption on a policy file provided from the control system.

In this case, the intrusion information stored in the data storing unit 120 may include at least one of a uniform resource locator (URL) and an internet protocol (P) address of a malware code file, network traffic information related with the malware code, and internal intrusion analysis result data.

The communication status management unit 130 may perform a function of checking a communication status between the interlocking client 100 and the interlocking server 200 which interlocking data is transmitted between the interlocking client 100 and the interlocking server 200. The communication status management unit 130 periodically checks the communication status between the interlocking client 100 and the interlocking server 200 and issues a warning message when the communication status is not normal.

To this end, when a request for checking the communication status is input from the interface unit 110, the communication status management unit 130 checks the communication status between the interlocking client 100 and the interlocking server 200. When there is no response for 10 seconds at the time of checking the communication status, the communication status management unit 130 ends the connection.

The communication status management unit 130 may check a status of a data transmission connection session through the data transmitting unit 150 and a status of the connection session through the data polling unit 160. In this case, the communication status management unit 130 transmits status information of the connection session to the interface unit 110.

When it is confirmed that any one of the data transmission connection session through the data transmitting unit 150 and the connection session through the data polling unit 160 is disconnected, the communication status management unit 130 tries to reconnect with the disconnection session.

When there is no data transmission until it exceeds a time set through a connection session between the interlocking client 100 and the interlocking server 20, the communication status management unit 130 may end the connection session and request mutual re-authentication between the interlocking client 100 and the interlocking server 200.

The security transporting unit 140 performs an operation for securing confidentiality and integrity of data when interlocking data on intrusion information transmitted from the client system and analysis information transmitted from the control system is transmitted and received.

In other words, the security transporting unit 140 receives a certificate route for mutual authentication between the interlocking client 100 and the interlocking server 200 and inspects the mutual authentication between the interlocking client 100 and the interlocking server 200 based on the certificate of the route to confirm the validity.

In this case, the security transporting unit 140 determines the validity of a device serial number included in the certificate to authenticate whether the device serial number is a permitted number.

The security transporting unit 140 connects a session for transport layer security (TLS) to exchange a secret key to be used for independent encryption communication and then ends the session connection for the transport layer security (TLS).

When the mutual authentication between the interlocking client 100 and the interlocking server 200 is completed, the secure transporting unit 140 may encrypt interlocking data transmitted and received between the interlocking client 100 and the interlocking server 200 using the secret key (symmetric key ARIA or SEED cipher algorithm).

When the intrusion information collected by the client system is stored in the data storing unit 120, the data transmitting unit 150 serves to transmit the intrusion information stored in the data storing unit 120 to the control system through the interlocking server 200 in accordance with the request of the interface unit 110. In this case, the data transmitting unit 150 processes the intrusion information stored in the data storing unit 120 in accordance with a transport format of the connection session between the interlocking client 100 and the interlocking server 200 and transmits the intrusion information.

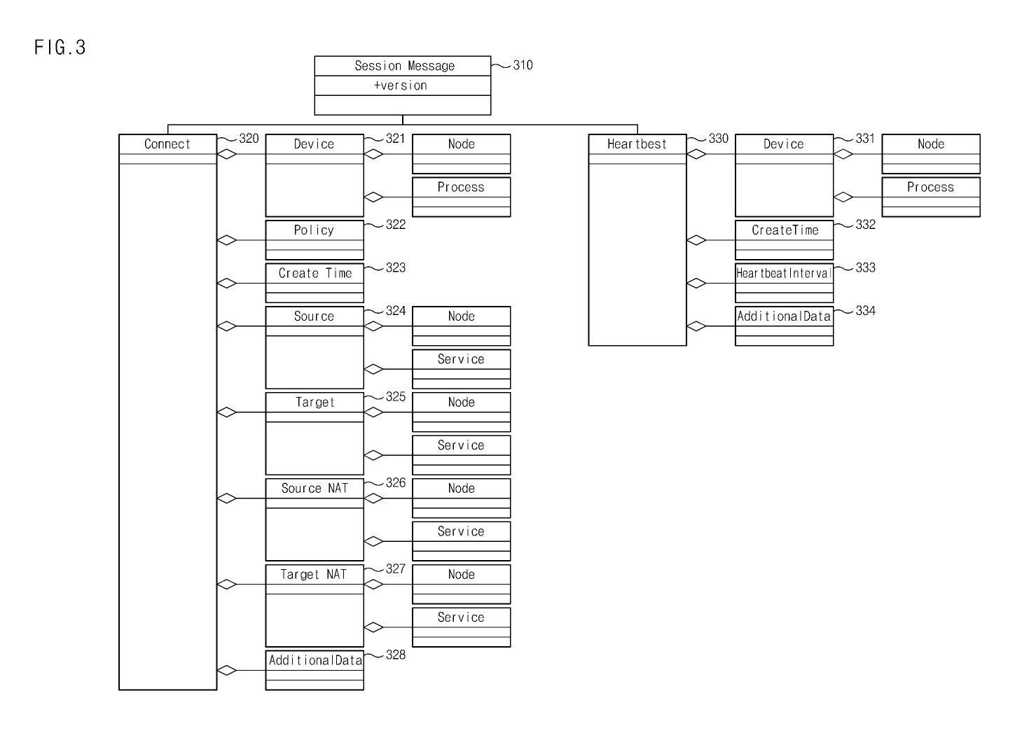

Here, the data transmitting unit 150 may be processed based on a predetermined data model. The data model will be described with reference to the exemplary embodiment of FIG. 3.

The data transmitting unit 150 may also provide malware code data or internal intrusion analyzing result data collected in the client system in addition to the intrusion information.

When a request for intrusion analysis information corresponding to the intrusion information which is already transmitted from the client system is input to the interface unit 110, the data polling unit 160 confirms whether an analysis result of the intrusion which is analyzed by the control system is present in the interlocking server 200. Here, the data polling unit 160 may confirm whether there is an intrusion analysis result from the data control unit 250 of the interlocking server 200 which will be described below.

When there is the intrusion analysis information in the interlocking server 200, the data polling unit 160 obtains the analysis information of the intrusion stored in the interlocking server 200 by a polling manner. In contrast, there is no intrusion analysis information in the interlocking server 200, the data polling unit 160 may periodically confirm whether there is the intrusion analysis result in the interlocking server 200.

In the meantime, the interlocking server 200 may include an interface unit 210, a data storing unit 220, a security transporting unit 230, a data receiving unit 240, and a data control unit 250.

The interface unit 210 serves to control the connection between the interlocking client 100 connected to the client system and the control system, control a function for sharing the intrusion analysis information of the control system corresponding to the intrusion information of the client system, and manage the interlocking data.

To this end, in the interface unit 210, a request for confirmation of an operation status of the interlocking server 200 from the control system and the interlocking client 100, and/or a request for storing and deleting data may be input. Therefore, the interface may check the operation status of the data storing unit 220, the security transmitting unit 230, the data receiving unit 240), and the data control unit 250 and then create a result thoseof and provide the created result.

The interface unit 210 may store data on intrusion information transmitted from the data transmitting unit 150 of the interlocking client 100 and intrusion analysis information provided from the control system in the data storing unit 220 or delete data stored in the data storing unit 220. In this case, the intrusion analysis information stored in the data storing unit 220 may be analysis information on one or more intrusions and may be stored correspondingly to the intrusion information.

Here, the intrusion analysis information stored in the data storing unit 220 may include at least one of an URL and IP address of a file which is detected as a malware, a pseudo intrusion attack behavior, an inflow path, and a changed circumstance of the malware file, and new intrusion attack analysis result data.

When the intrusion analysis information provided from the control system is transmitted, the interface unit 210 may perform encryption based on the policy file of the control system.

The security transporting unit 230 performs an operation for securing confidentiality and integrity of interlocking data transmitted and received when intrusion information is received from the interlocking client 100 or intrusion analysis information transmitted from the control system is transmitted.

A role and a function of the security transporting unit 230 are the same as the security transporting unit of the interlocking client 100, so that a redundant description will be omitted.

The data receiving unit 240 serves to receive and process interlocking data transmitted by the data transmitting unit 150 of the interlocking client 100, that is, intrusion information.

In this case, the intrusion information is transmitted from the data transmitting unit 150 of the interlocking client 100 which is mutual-authenticated by the security transporting unit 230, the data receiving unit 240 receives the information and stores the information in the data storing unit 220. When the intrusion information is transmitted from the data transmitting unit 150 of the interlocking client 100, the data receiving unit 240 may also receive the intrusion information after inquiring the interface unit 210 whether to receive the data.

The data control unit 250 serves to provide the intrusion analysis information from the control system stored in the data storing unit 220 to the interlocking client 100 by a polling manner.

In this case, the data control unit 250 processes the intrusion analysis information in accordance with a transport format of the connection session between the interlocking server 200 and the interlocking client 100.

As described above, in the interlocking system according to an exemplary embodiment of the present invention, intrusion information is provided from the interlocking client 100 to the interlocking server 200 which have different network domains in a domain different from that of the interlocking client 100. In this case, the interlocking server 200 is provided with intrusion analysis information through the control system and the intrusion analysis information is shared by the interlocking clients 100. Therefore, intrusion information may be shared between different network domains and the analysis information thereof may also be shared. In this case, the intrusion information and the analysis information thereof are shared so that it is possible to promptly cope with the intrusion.

FIG. 3 is a view illustrating a data model of intrusion information of an interlocking system according to an exemplary embodiment of the present invention.

As illustrated in FIG. 3, a data model which is applied to process the intrusion information has a tree structure including a plurality of classes.

First, a top class of the data model is a session message class 310 which is a generic term of a message which is exchanged between different network domains.

The session message class 310 includes a connect class 320 including session log information for network connection and a heartbeat class 330 including operation status information of a system.

First, the connect class 320 is a class for storing intrusion information. The connect class expresses a type of a log which is generated by connection trial and access in an intrusion prevention system and indicates all information regarding the connection including not only internal connection trial, but also external connection trial.

The connect class 320 may be connected to a device class 321, a policy class 322, a creatTime class 323, a source class 324, a target class 325, a sourceNAT class 326, a targetNAT class 327, and an additionalData class 328.

Here, the device class 321 is a class which confirms which system transmits a connect message. Property information of the device class 321 may be a device ID, a manufacturing company, a model name, a software (SW)/hardware (HW) version, a SW/HW type, an operating system type, and an operating system version.

The policy class 322 is a class regarding the policy information.

The creatTime class 323 is used to represent date and time information when the connect message is created in the system. As a date and time representing type of the creatTime class 323, a network time protocol (NTP) time stamp may be mainly used.

The source class 324 is a class for sender information which tries connection to create session connection. Property information of the source class 324 may be a unique identifier for the source, a network interface, sender host information (network address and name), host user information, and network service information.

The target class 325 is a class for destination information which tries connection to create session connection. Property information of the target class 325 may be a unique identifier for the target, a network interface, sender host information (network address and name), host user information, and network service information.

The source NAT class 326 is a class for network address translated (NAT) sender information which tries the connection to create session connection. Property information of the source NAT class 326 may be a unique identifier for the network address translated source, a network interface, sender host information (network address and name), host user information, and network service information.

The target NAT class 327 is a class for network address translated (NAT) destination information which tries the connection to create session connection. Property information of the target NAT class 327 may be a unique identifier for the network address translated target, a network interface, sender host information (network address and name), host user information, and network service information.

The additionalData class 328 is a class of expressing additional information which does not correspond to a data model and is used to provide not only data such as an integer or a character string, but also complex data such as a packet header.

In the meantime, the heartbeat class 330 is a class for storing operation status information of the system. The system uses a heartbeat message to notify a current system status to a manager. The heartbeat message may be transmitted at a predetermined time interval (for example, ten minutes) or at every predetermined time (for example, hourly).

The reception of the heartbeat message means that the system is being executed to a security manager and absence of the heartbeat message indicates that there is a problem in a system or network connection status. Therefore, it needs to be supported so that all security managers receive the heartbeat message, but whether to use the heartbeat message by the system is optional. Therefore, a developer of management software may set whether to use the heartbeat message based on a function of the system.

The heartbeat class 330 may be connected to the device class 331, the creattime class 332, a heartbeatinterval class 333, and an additionaldata class 334.

Here, the device class 331 is a class which confirms which system transmits the heartbeat message. Property information of the device class 331 may be a device ID, a manufacturing company, a model name, a SW/HW version, a SW/HW type, an operating system type, and an operating system version.

The creattime class 332 is used to represent date and time information when the heartbeat message is created in the system. As a date and time representing type of the creattime class 332, a network time protocol (NTP) time stamp may be mainly used.

The heartbeatinterval class 333 is a class regarding interval information when the heartbeat message is transmitted.

The additionaldata class 334 is a class for representing additional information which does not correspond to the data model. The additionaldata class 334 may be used to provide not only data such as an integer or a character string, but also complex data such as a packet header.

An operation flow of the control device according to the exemplary embodiment of the present invention configured as described above will be described in detail.

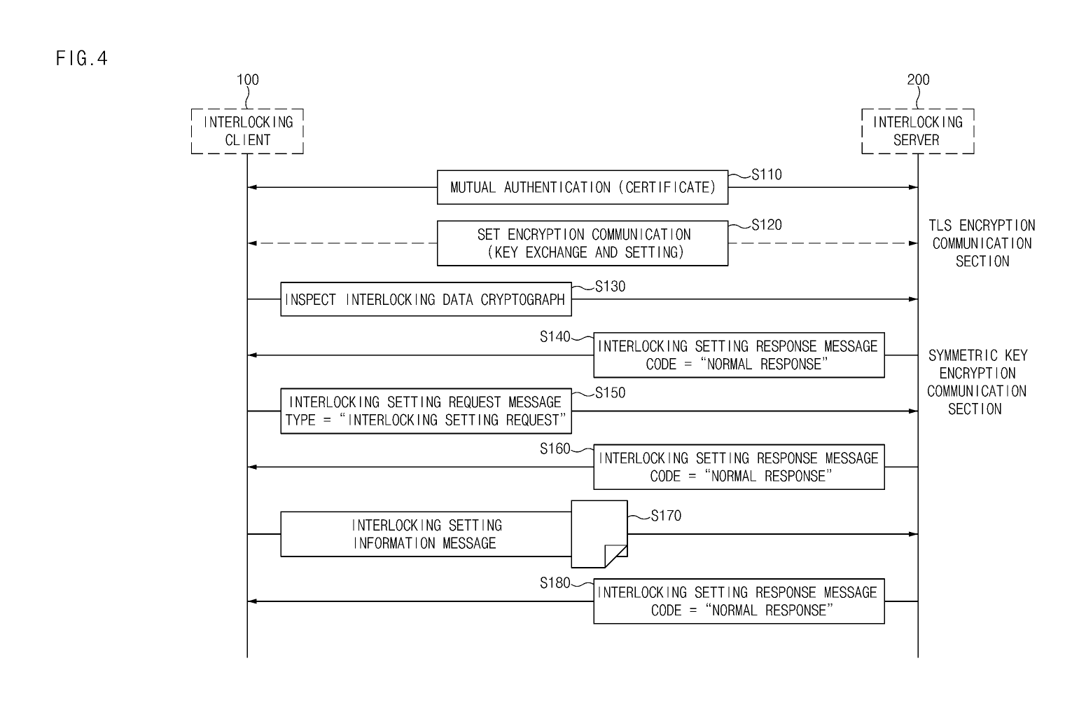

FIG. 4 is a view illustrating a flow of an authenticating operation of an interlocking system according to an exemplary embodiment of the present invention.

Referring to FIG. 4, when the interlocking client 100 and the interlocking server 200 of the interlocking system exchange interlocking data such as intrusion information and intrusion analysis information, the interlocking client 100 and the interlocking server 200 of the interlocking system perform mutual authentication between the interlocking client 100 and the interlocking server 200 to secure the confidentiality and integrity of the interlocking data. In this case, the mutual authentication operation between the interlocking client 100 and the interlocking server 200 may be performed by the security transporting unit 230 provided in each of the interlocking client 100 and the interlocking server 200.

First, for the mutual authentication between the interlocking client 100 and the interlocking server 200, the interlocking client 100 and the interlocking server 200 provide authentication routes for mutual authentication and perform the mutual authentication based on the certificate on the certificate route in step S110.

In step S110, the interlocking client 100 and the interlocking server 200 may determine the validity of a device serial number included in the certificate.

When the mutual authentication is completed in step S110, a session for security transport is connected and the interlocking client 100 and the interlocking server 200 sets encryption communication by exchanging a secret key and performing a setting operation in step S120.

In this case, the interlocking client 100 encrypts the interlocking data through the secret key set in step S120 to transmit the interlocking data to the interlocking server 200.

In the meantime, when the symmetric key encryption connection between the interlocking client 100 and the interlocking server 200 abnormally ends or a part of connected sessions ends, the interlocking client 100 may transmit a “transaction aloha” message to the interlocking server 200 for checking a cryptograph of the interlocking data in step S130.

In this case, the interlocking server 200 checks validity of a secret key used for the symmetric key from the “transaction aloha” message transmitted from the interlocking client 100 in step S130 and determines whether the secret key is normal. The interlocking server 200 transmits a result code (for example, code=“normal response”) for the validity checking of the secret key to the interlocking client 100 together with an interlocking setting answer message in step S140.

In this case, when the validity of the secret key is determined to be normal through the “transaction aloha” message, the interlocking server 200 does not retry the session connection for the purpose of secure transport but permits the symmetric key encryption connection using a secret key which is currently being used.

Therefore, the interlocking client 100 transmits an interlocking setting request message to the interlocking server 200 in step S50 and the interlocking server 200 transmits the interlocking setting response message for the interlocking setting request message to the interlocking client 100 in step S160. Thereafter, the interlocking client 100 transmits an interlocking setting information message including interlocking setting information to the interlocking server 200 in step S170 and the interlocking server 200 responses therefor in step S180, so that the interlocking client 100 and the interlocking server 200 are symmetric key encryption connected.

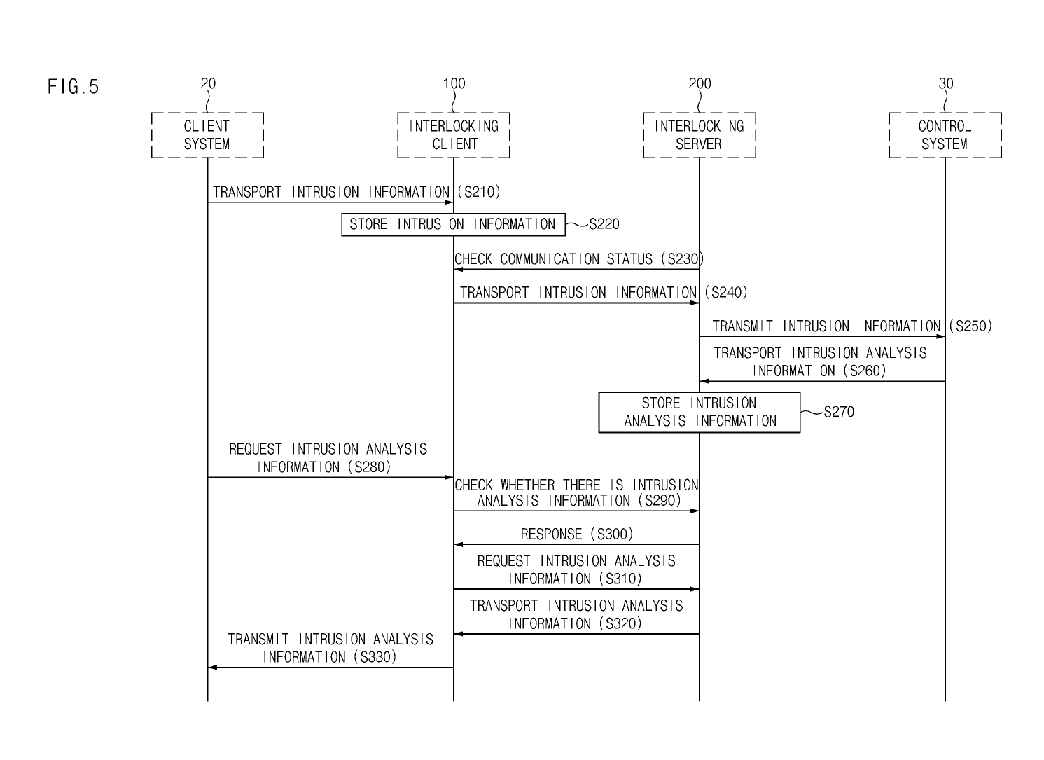

FIG. 5 is a view illustrating a flow of an operation of an interlocking method according to an exemplary embodiment of the present invention.

Referring to FIG. 5, when intrusion information is detected, the client system 20 transports the intrusion information to the connected interlocking client 100 in step S210.

In this case, the interlocking client 100 stores the intrusion information provided from the client system 20 in step S220 and checks the communication status between the interlocking client 100 and the interlocking server 200 to transmit the stored intrusion information to the control system in step S230.

When the connection session between the interlocking client 100 and the interlocking server 200 is normal, the interlocking client 100 may transport the intrusion information stored in step S220 to the interlocking server 200 in step S240.

Therefore, the interlocking server 200 transmits the intrusion information to the control system 30 in step S250 to analyze the intrusion information transported in step S240.

The control system 30 comprehensively analyzes the intrusion information transmitted in step S250 and transports the intrusion analysis information to the interlocking server 200 in step S260. Therefore, the interlocking server 200 stores the intrusion analysis information transported in step S260 in step S270.

When there is a request of intrusion analysis information from the client system 20 in step S280, the interlocking client 100 accesses the interlocking server 200 to check whether there is intrusion analysis information in step S290. In this case, the interlocking client 100 may confirm that there is the intrusion analysis information from the response of the interlocking server 200 in step S300.

When it is confirmed that the intrusion analysis information is present in the interlocking server 200, the interlocking client 100 requests the intrusion analysis information to the interlocking server 200 in step S310 and the interlocking server 200 transports the intrusion analysis information to the interlocking client 100 in a polling manner in step S320.

Therefore, the interlocking client 100 may transmit the intrusion analysis information transmitted in step S320 to the client system 20 in step S330.

The interlocking server 200 and the interlocking client 100 according to the exemplary embodiment operated as described above may be implemented as an independent hardware device. In the meantime, the interlocking server 200 and the interlocking client 100 according to the exemplary embodiment may be driven to be included in different hardware devices such as a microprocessor or a general purpose computer system as at least one processor.

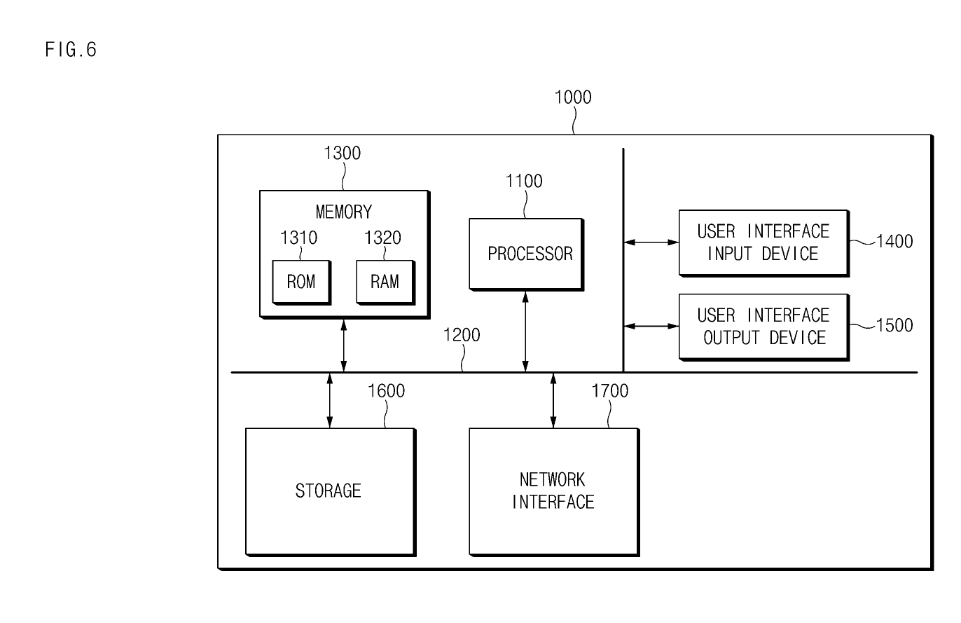

FIG. 6 is a view illustrating a computing system to which an apparatus according to an exemplary embodiment of the present invention is applied.

Referring to FIG. 6, a computing system 1000 may include at least one processor 1100, a memory 1300, a user interface input device 1400, a user interface output device 1500, a storage 1600, and a network interface 1700 which are connected to each other through a bus 1200.

The processor 1100 may be a semiconductor device which performs processings on commands which are stored in a central processing unit (CPU), or the memory 1300 and/or the storage 1600. The memory 1300 and the storage 1600 may include various types of volatile or non-volatile storage media. For example, the memory 1300 may include a read only memory (ROM) and a random access memory (RAM).

The method or a step of algorithm which has been described regarding the exemplary embodiments disclosed in the specification may be directly implemented by hardware or a software module which is executed by a processor 1100 or a combination thereof. The software module may be stored in a storage medium (that is, the memory 1300 and/or the storage 1600) such as a RAM, a flash memory, a ROM, an EPROM, an EEPROM, a register, a hard disk, a detachable disk, or a CD-ROM. An exemplary storage medium is coupled to the processor 1100 and the processor 1100 may read information from the storage medium and write information in the storage medium. As another method, the storage medium may be integrated with the processor 1100. The processor and the storage medium may be stored in an application specific integrated circuit (ASIC). The ASIC may be stored in a user terminal. As another method, the processor and the storage medium may be stored in a user terminal as individual components.

It will be appreciated that various exemplary embodiments of the present invention have been described herein for purposes of illustration, and that various modifications, changes, and substitutions may be made by those skilled in the art without departing from the scope and spirit of the present invention.

Therefore, the exemplary embodiments of the present invention are provided for illustrative purposes only but not intended to limit the technical spirit of the present invention. The scope of the technical concept of the present invention is not limited thereto. The protective scope of the present invention should be construed based on the following claims, and all the technical concepts in the equivalent scope thereof should be construed as falling within the scope of the present invention.

1. An intrusion information interlocking system, comprising:
at least one interlocking client which is connected to a client system for collecting session information; and
an interlocking server for analyzing the session information.

2. The system of claim 1, wherein intrusion information of the session information collected by the client system includes at least one of a uniform resource locator (URL) and an internet protocol (IP) address of a malware code file, network traffic information related with the malware code, and internal intrusion analysis result data.

3. The system of claim 1, wherein the interlocking client and the interlocking server receive a certificate route for mutual authentication between the interlocking client and the interlocking server and check validity of communication connected between the interlocking client and the interlocking server based on the certificate of the route to perform mutual authentication.

4. The system of claim 3, wherein the interlocking client and the interlocking server connect a session for transport layer security (TLS) to exchange a secret key to be used for independent encryption communication and check the validity of the secret key to try symmetric key encryption connection.

5. The system of claim 1, wherein the interlocking client includes a communication status management unit which periodically checks a communication status of a connection session for transporting the intrusion information between the interlocking client and the interlocking server and a connection session for polling the intrusion analysis information stored in the interlocking server.

6. The system of claim 5, wherein when the connection session between the interlocking client and the interlocking server is disconnected or there is no response for a predetermined time or longer, the communication status management unit ends the connection session and requests the mutual authentication.

7. The system of claim 1, wherein the session information is represented by a predefined data model.

8. The system of claim 7, wherein in the data model, a session message class is defined in the top class, and in a lower class of the session message class, a connect class which includes session log information for network connection and a heartbeat class which includes operation status information are defined.

9. The system of claim 8, wherein in the connect class, at least one of information on a device, policy information, time information created for the connect message, source information, destination information, source information and destination information in which a network address for creating the session connection, and additional information is defined.

10. The system of claim 8, wherein in the heartbeat class, at least one of information on a device, time creation information of the heartbeat message, information on an interval of the heartbeat message is transmitted, and additional information is defined.

11. The system of claim 1, wherein the intrusion analysis information includes at least one of a URL and IP address of a file which is detected as a malware, a pseudo intrusion attack behavior of the malware file, an inflow path, and a changed circumstance of the malware file, and new intrusion attack analysis result data.

12. An intrusion information interlocking method, the method comprising:
receiving and storing, by an interlocking client, intrusion information from a client system which collects session information of intrusion, in different network domains;
checking, by the interlocking client, a communication status between the interlocking client and the interlocking server to transmit the intrusion information to the interlocking server;
transmitting, by the interlocking sever, the intrusion information in different network domains received from one or more interlocking clients to a control system;
receiving, by the interlocking server, analysis information on the intrusion information from the control system to store the intrusion analysis information; and
sharing stored intrusion analysis information by the interlocking server and the interlocking client when there is a request of the intrusion analysis information from the interlocking client.

13. The method of claim 12, further comprising:
performing mutual authentication by receiving a certificate route for mutual authentication between the interlocking client and the interlocking server and checking validity of communication connected between the interlocking client and the interlocking server based on the certificate of the route.

14. The method of claim 13, wherein the performing of mutual authentication includes:
connecting a session for transport layer security (TLS);
exchanging a secret key used for encryption communication through the session connected for secure transmission; and
checking validity of the secret key to try symmetric key encryption connection.

15. The method of claim 12, further comprising:
periodically checking, by the interlocking client, a communication status of a connection session for transmitting intrusion information between the interlocking client and the interlocking server and a connection session for polling the intrusion analysis information stored in the interlocking server to end the connection session when the connection session is disconnected and there is no response for a set time or longer to request mutual authentication.

16. The method of claim 12, wherein in the transmitting of the intrusion information to the interlocking server, the intrusion information collected by the client system is processed based on a predetermined data model and the processed data is transported to the interlocking server.
